(19) United States
(12) Patent Application Publication
(10) Pub. No.: US 2025/0305321 A1
(43) Pub. Date: Oct. 2, 2025

(54) CONNECTION SYSTEM

(71) Applicant: Think Recyclates Pty Ltd, Bellarine, Victoria (AU)

(72) Inventor: Jack Fitzgerald, Bellarine, Victoria (AU)

(21) Appl. No.: 18/881,487

(22) PCT Filed: May 10, 2023
(86) PCT No.: PCT/AU2023/000003

§ 371 Date: Jan. 6, 2025

(30) Foreign Application Priority Data
Jul. 7, 2022 (AU) 2022901910

(51) Int. Cl. E04H 17/14

(52) U.S. Cl. CPC E04H 17/1488

(57) ABSTRACT

A connection system for joining members of a structure, said system comprising an anchor element fixed to a primary structure or structural member and an adapter element fixed to said anchor element, said adapter element being adapted to receive, support and be connected to the end of a secondary structural member, the system permitting the assembly so created be readily, partially or completely, dismantled; said anchor element being fixed in place using conventional fastening means, said adaptor element being slidingly engaging with complementary shapings of said anchor element and locked in place on said anchor element by the installation of locking means, an end of said structural member being entered into and secured to said adaptor element by frictional engagement, by bonding or, where a tensile loading is to be applied to said structural member, by means of conventional fastenings.

### CROSS-REFERENCE TO RELATED APPLICATIONS

This Application is a Section 371 National Stage Application of International Application No. PCT/AU2023/000003, filed May 10, 2023, and published as WO 2024/007047 A1 on Jan. 11, 2024, in English, which claims priority to and the benefit of Australian Patent Application No. 2022901910, filed Jul. 7, 2022, the contents of which are incorporated herein by reference in their entireties.

### FIELD OF THE DISCLOSURE

This invention relates generally to methods of joining, in a removable way, secondary structural members to primary structures or structural members. It relates specifically to methods in which an anchor element is fixed to a primary structure or structural member, an adapter element is fixed to the anchor element and the adapter element able to accommodate and support the end of a secondary structural member; all able to be readily, partially or completely, dismantled for removal.

### BACKGROUND OF THE DISCLOSURE

Situations are common in which it is necessary to connect a secondary structural member to a primary structure or structural member. Examples of such situations are: connection of bed side rails to bed heads or transverse members; connection of beams to uprights in shelving or pallet racking; assembly of scaffolding; assembly of pedestrian barriers; erection of exhibition booths; and assembly of other temporary structures. While it is also common for primary structures and structural members to be of a vertical orientation and secondary structural members to be of a horizontal orientation, many other orientations of both may be required.

In the Rail Fence and Bracket System taught by Bertato in CA 2 870 710, a fence system has upright posts and transverse fence rails, formed of hollow rectangular tubular construction and having internal ribs formed within the hollow interior; a plurality of angular mounting brackets defining a transverse insertion portion and an upright attachment portion, and wherein the transverse insertion portions are adapted to make a frictional fit within the interior of said hollow tubular rails, and a plurality of fastening holes in said attachment portions, whereby the same may be secured to a fence post.

The Bracket Attachment System taught by Marron in US 2014/0231739 provides a universally adjustable metal two bracket attachment system for metal fence posts for the attachment of various types of fencing materials or fence sections; the subject metal fence post attachment bolt and bracket system being simple and easy to install, is universally adjustable to round or square metal fences posts, by bolting onto “off the shelf” non-adjustable fence post brackets; the subject brackets allowing both full section metal fencing with the bracket mounted with the open end side ways, and three rail metal fencing with the bracket facing up.

In the Attachment Mechanism and Fence System Using the Same taught by Rowley et al in US 2011/0001104, a fence system includes first and second posts attached in the ground and a rail coupled to the first post and the second post with a female member attachment mechanism and a lip; the fence system also including a slat including a male member attachment mechanism with a flap and a locking mechanism defining a step, the slat being coupled to the rail such that the male member attachment mechanism is coupled to the female member attachment mechanism and the step abuts the lip; should a force be applied to remove the male member attachment mechanism from the female member attachment mechanism, the lip exerts a force on the step resisting the force.

The Rail End Cover taught by McGinness et al in U.S. Pat. No. 8,047,485 provides a universal rail mounting bracket for attachment of a handrail or fence rail to a support structure, a rail end cover being insertable over the rail end after the rail has been mounted to the support structure with the bracket, the rail end cover being provided to cover any unsightly gaps or uneven cuts which may have occurred during manufacture or installation of the rail.

The Clip for Adjustable Mounting of a Fence Rail to a Fence Post taught by Platt in US 2007/0045603 discloses a fence rail clip for attaching a fence rail to a vertical fence post, the rail clip having a bracket with a raised central area flanked by two lower lateral areas and a rail connector that, vertically or horizontally, slidingly engages the central area of the bracket, the lateral areas defining locations for connecting the bracket to a vertical post; the rail connector has a rail receiving receptacle into which an end of a rail may be inserted, the bracket optionally including indicia or characters for determining the correct position of attachment of the rail connector to the bracket; when the position of the rail connector is altered by sliding the rail connector relative to the bracket, the angle of the rail receiving receptacle is altered, thereby changing the angle at which a rail may be attached to the post.

In the Stable, Non-locking Picket Fence System taught by Hellenbrand in US 2018/0320404, a fencing system has at least two engaging elements, two rails extending along respective upper and lower rail axes with a generally hollow rectangular or four-sided cross-section; the rails have a horizontal top wall between first and second vertical rail sidewalls that depend downwardly to define an internal cavity, at least two attachment legs extend inwardly towards each other from the sidewalls, vertical picket posts extend between through holes in the upper and lower horizontal rails; the picket post includes multiple grooves, the grooves receiving the posts without penetration into any internal cavities of the upper and lower rail, and the posts are forced inwardly into the grooves by elastic memory in the sidewalls, the posts within grooves not being in locked engagement with the grooves, but held in place by the force of the elastic memory, the posts withdrawable from the grooves by overcoming the elastic force.

The Fencing System taught by Moreby et al in GB 2 094 368 comprises two posts and a cross rail, the posts each having a first attachment means which interengage with a second attachment means of the cross rail upon movement of the cross rail in a predetermined path transverse to the longitudinal axis thereof releasably to attach the cross rail to the posts so that the cross rail extends between and is supported by the posts; a fencing panel and means releasably to connect the fencing panel to the cross rail, the means hooking into a staple, the connecting means being a resilient clip which hooks behind a rail on the fencing panel and clips over the cross rail, the bottom of the posts being wedgeable to a base plate.

The Fastening Clip for Attaching Rails and Posts in Fence Structure and Attachment Method of the Same taught by Ratanasiriwilai in US 2007/0034846 comprises a post clipping portion for clipping an outer surface of the post wherein each end region thereof is a connecting portion, and each end of the connecting portions is a rail clipping portion having an upper end or a lower end being a rail-edge clipping portion for clipping an upper surface or a lower surface of the rail respectively and the rail clipping portion has a through hole for inserting of a bolt.

The Temporary Protective Handrail Connecting Device for Stairs taught by Yang et al in CN215889434 comprises a fixing plate and a fixing steel pipe, and a connecting adjusting mechanism arranged outside the fixing steel pipe, the connecting adjusting mechanism comprising a plurality of mounting blocks mounted outside the fixed steel pipe with every two adjacent mounting blocks being perpendicular to each other, adjusting grooves being formed in the mounting blocks, balls are rotationally connected into the adjusting grooves, connecting columns are mounted outside the balls, and ring sleeves are mounted at the ends, away from the balls of the connecting columns; the interior of the ring sleeve is slidably connected with a protection steel pipe, and the interior of the ring sleeve and the interior of the protection steel pipe are jointly slidably connected with an anti-disengaging rod, the installation angle of the protective barrier being adjustable through the cooperative use of the installation block, the adjusting groove, the ball body and the ring sleeve; the arrangement resulting in a great improvement of the safety of the protective barrier, during installation of the protective barrier the uncomfortable angle of the ring sleeve is avoided, and the butt joint of the protective barrier at various angles is facilitated.

In the Bracket for Fence Rail or Panel taught by Perry in GB 2 401 616a fence bracket comprises a main body which may be rectangular, square, semicircular or triangular in correspondence to the cross-section of a fence rail, and has at least two flanges adapted to overlie a side of the rail or panel, and at least one tab with at least one hole for securing the bracket to the face of a fence post, the bracket being attachable to the panel or rail before attachment to the fence post, the flanges and tabs optionally being rectangular, triangular, or part-circular.

The Rail and Fence Bracket Apparatus taught by Spruill in U.S. Pat. No. 6,543,751 includes a back piece, a bottom piece, and a bottom support system, the back piece including screw attachment openings, the edges of the bracket being adapted to facilitate installation of a supported rail, an offset spacer being attached to the back piece to allow for air circulation around said supported piece, the bottom piece able to be curved to support rounded rails and include a water passage opening to allow for drainage, the bottom support system including an angle bracket, the bracket joints being strengthened with fillets, side pieces being provided for supporting and holding the installed rail; the unit is able to be designed with an engineered failure mode to allow for bracket failure to occur before a rail failure would occur, a rail retaining system may be used to retain the rail in position and a rail slot extension may be used to support the bracket in association with a rail cutout.

The Fence Construction System taught be Espinueva in U.S. Pat. No. 5,192,056 allows for simple and rapid construction of a wooden fence, the system including upper and lower metal brackets for fastening horizontal rail members to vertical fence posts; included in the system are quick attachment means for rapid assembly of the fence, the system allowing a durable traditional style good neighbor fence to be rapidly assembled from precut or standard sized lumber.

In the Multi-component Conical Corner Structure for Shelving taught by McAllister et al in US 2010/0108631 a shelving unit comprises a plurality of upright support posts and shelves having multiple corners with a multi-component corner structure at each corner of the shelf for releasably connecting the shelf to the posts, each corner structure comprising a two piece base segment and a substantially frictionless outside interlocking segment, the two piece base segment including a housing fixedly connected to a shelf corner and a substantially frictionless inner liner within the housing, the outside interconnecting segment including outwardly extending flanges that engage vertically oriented opposed undercut slots on the inner liner to facilitate interconnection of the base and interlocking segments; both segments include partial frusto conical surface portions that engage a frusto conical clamping sleeve on the support posts to facilitate releasable connection of the shelf to the posts, the substantially frictionless material of the inner liner and outside interlocking segment enabling ease of assembly and disassembly as well as a tight wedging fit of the components.

In the Mechanical Fastener for Frame of Bed taught by Fouks et al in U.S. Pat. No. 3,780,386, great flexibility of use and reduction of inventory are made possible by the convertible bed rail connector means which allows connection of a bed rail means to a bed post means alternately by hook means or bolted means while at the same time allowing the bed rail means to either support the bed post means as would be the case in a “Hollywood” bed arrangement or will allow the bed rail means to be supported by the bed post means as is the case in a conventional bed stead arrangement; an angular bracket member is movably coupled to a bed rail means so that hook means on the bed rail means may pass through a slot in the bracket to effect hook coupling means and to be retracted to a position where the bracket may be connected to the bed post means for either supporting the bed rail means or being supported by the bed rail means.

In the Bed Frame Having Releasably Interlocked Side Rails and Crossbars taught by Spitz in U.S. Pat. No. 3,952,345 a bed frame of the knockdown type has a pair of side rails and at least one connected adjustable end crossbar cooperable to provide a supporting frame structure for an associated box spring, in which brackets on the side rails are formed to provide sockets for respectively laterally receiving associated end portions of a crossbar therein into seated position where coacting parts respectively on the brackets and crossbar have interlocking engagement and function to retain the end portion of the crossbar against endwise withdrawal from the associated socket.

The Temporary Protective Barrier With Adjustable Angle taught by Shen et al in CN214996247 comprises vertical rods and transverse rods, the transverse rods being connected between the adjacent vertical rods through connecting shafts, the vertical rod comprising a connecting plate and a rod body, the connecting plate being arranged at the bottom end of the rod body with connecting holes formed in the rod body at intervals, the cross rods being movably connected into the connecting holes; the cross rod is movably connected in the vertical rod, the angle of the cross rod being adjustable up and down so that the ladder stand is suitable for base structures such as stairs and ramps with different inclined planes and angles; turnover utilization rate and applicability are high and the ladder stand does not need to be produced in batches independently according to the existing structure; the device has the advantages of simple structure, light weight and convenience in assembly and disassembly, saves a large amount of manual assembly and disassembly time and cost, improves the construction efficiency, and effectively reduces the cost.

In the Dovetail Joint Construction taught by Lutz in U.S. Pat. No. 5,762,410, one or a pair of aligned dovetail grooves secure various shelves to supports depending upon whether the shelf is an upper or lower unit, vertical supports have male dovetail projections formed on each end for mating with a groove, a wedge projection is formed on the support end adjacent to the male dovetail projection for wedging against the shelf in interference fit when the male and female elements are assembled, the supports have a width less than that of the shelves so that the dovetail joints are only visible from the shelving rear, the wedge projections are sufficiently small so as to not be observable from the shelving front; a particular shelf construction employs upper and lower shelves each comprising a dual construction of an upper and lower member, a triangular brace is secured to the lowermost shelf for support when the shelving is hung on a wall; all shelving members and supports are secured by identical dovetail joints and are collapsible since no dowels or adhesive is used to permanently secure the elements.

In the Shelving Beam taught by Lynch in NZ 512360, a demountable shelving beam is provided for use between opposing sides of two spaced apart shelving uprights, two sets of end lugs with rebates inward thereof being provided, one above the other at each end of the beam, at one end of the beam the rebates being of elongate form running longitudinally of the beam, at the other end the rebates being in the form of an inverted “V” shape adjacent the lugs with a ramp leading downwardly and away from the rebates; the spacing of the lugs above one another match the spacing of slots in the sides of the uprights; assembly being by first presenting the end of the beam to the upright and inserting the lugs into the slots such that the side wall of the upright locates in the rebates, moving the beam to provide clearance for its end to be presented to the opposing side of the upright, the beam then being moved to insert the lugs at that end into the associated slots thereof; by downwardly pressing the beam end the engagement of the ramp of the wall of the upright dislodges the beam wedging the wall of the upright in the inverted “V” shaped rebates, the action also causing the lugs at end of the beam to butt up on the inside of the wall upright, thus interlocking the beam in place; the beam is demounted using the reverse procedure.

In the Improvements Relating to Shelving Structures taught by Barratt in GB 2 354 934, a shelving structure includes receiving members and shelf support members, the receiving members being provided with ‘P’ shaped, keyhole apertures, the shelf mounting members being provided with primarily U shaped connectors comprising an engagement part and a retention part; in operation connectors are inserted into the apertures and moved downwards causing the retention parts to lie flat against the receiving members, thus preventing lateral movement between the members; a slight tapering of the narrow part of the apertures serves to retain the engagement of the connectors in a wedging fit.

In the Improvements in Shelving Systems taught by Maxwell in GB1311960, a shelf support comprises a wall mountable upright with a planar front surface and longitudinal grooves in its side edges, a shelf bracket and a pair of clamps with flanges which engage the grooves and the bracket so that a part of the bracket is clamped to the upright between its front surface and a part of the clamps; the clamps being drawn together by a screw to cause wedging engagement of similarly inclined faces of the upright and the clamps whereby the bracket is forced into engagement with the front surface.

In the Scaffolding System taught by Peralta in DE19919358, vertical tube uprights and individual and/or multiple railing tubes comprise a scaffolding with holding devices for fixture of one of the railing tubes to the tube uprights, wedge boxes being provided on the uprights for fixture in relation to an opposing wall at an angle to them, locking components being provided for wedging the railing tubes, which have at least one guide slot engaged with the wedge box, each locking component having a spring component for wedging the railing tube in its locked position.

In the Improvements in Fencing taught by Moore in GB 599,042, a fence is built up of uprights connected by horizontal rails, the enclosed space being filled by a network consisting of horizontal and vertical elements welded together at their intersections, the uprights a being of T or of channel section, and the rails of L-section, the vertical elements of the net passing through holes in the horizontal parts of the rails, the attachment of the rails to the posts being effected by providing a slot in each end of the rails and a column of similar slots at top and bottom of the posts, a deformable staple being passed through a selected pair of slots and the slots in the two abutting rails, the slots allowing the rails to be suitably adjusted above the ground, and permitting the fence to be erected up and down a slope; the lower end of each post may be pointed and passed through a slot in an Lpiece buried in the ground, or the end may be simply buried in concrete blocks, intermediate round rods may pass through both rails and be welded thereto and to the net; a gate is formed by bending an angle strip into D form and fitting a vertical across its ends, network being inserted as before; a modified form of fence is provided having a tubular top rail and tubular uprights, the connection being effected by a cap having flanges and depending tongues joined together by a bridge and plugged into the uprights, lugs depending from the cap engaging the rails and the tops of the uprights are suitably recessed to receive the rails, half-straps are riveted to, and embrace, the lower ends of the uprights for bolt and nut attachment to the angular bottom rails.

In the Fence and Fence Connection Apparatus and Method taught by Goedecke in WO 2017/100040 a connector assembly and method are provided for the construction of a no-weld pipe fence, a no-weld fence end brace, or a no-weld fence corner brace, the connector assembly including (a) a bolt, a threaded pin, or a hinge knuckle structure which is attachable to a fence post and (b) an attachment sleeve which can be slidably nested on the end of a pipe rail or brace member, the attachment sleeve being connectable to the bolt, threaded pin, or hinge knuckle structure in a manner which allows the pipe rail or brace member to be pivoted to a horizontal position or to any other desired angle on the fence post and then locked in place.

In the prior art examples detailed, some are complicated, requiring multiple manufacturing processes for their production, rendering them unnecessarily expensive; some require specific tools to install or dismantle them and are not adapted for ready removal; some have an untidy and unattractive ‘mechanical’ appearance; some are limited to the use of specific materials; and some are made for narrow or specific applications.

### SUMMARY

An exemplary aspect of the present application provides a connection system employing a small number of designs with applicability to multiple applications; a system adapted to high volume production, using high-rate, repetition manufacturing processes at a low production cost; a system that is able to be installed and dismantled quickly and easily with a minimum of tools; a system the components of which are easily coloured during the manufacturing process; a system having components of a neat, attractive appearance; a system the components of which may be made from metal alloy or polymer materials; and a system readily adapted to a variety of applications.

According to an exemplary aspect, a connection system adaptable to a variety of applications comprises an anchor element fixed to a primary structure or structural member, an adaptor element slidingly engaged with and lockable to the anchor element, and a secondary structural member engaged with and secured to the adaptor element, the adaptor element being made in a range of forms to accommodate secondary structural members of a variety of transverse cross-sectional shapes. Various provisions are made to fix the anchor element to different surfaces for different applications and an embodiment is provided in which the adaptor element is pivotally supported to permit the angular displacement of the secondary structural member.

### BRIEF DESCRIPTION OF THE DRAWINGS

The various aspects of the present invention will be more readily understood by reference to the following description of preferred embodiments given in relation to the accompanying drawings in which:

FIG. 1 is a composite isometric view of the anchor element, adaptor element and structural member of the present invention;

FIG. 2 is a face view of the interior of the adaptor element;

FIG. 3 is a face view of the outer surface of the anchor element;

FIG. 4 is a side view of the anchor element of FIG. 3;

FIG. 5 is a transverse cross-sectional view on A-A of the anchor element of FIG. 3;

FIG. 6 is a fragmentary view of one corner of the adaptor element of FIG. 2;

FIG. 7 is a face view of the outer surface of the anchor element of FIG. 3 adapted for the installation of locking provisions;

FIG. 8 is a face view of the interior of the adaptor element of FIG. 2 adapted for the installation of locking provisions;

FIG. 9 is a longitudinal cross-sectional view through a medial plane parallel to the greater sides of the adaptor element of FIG. 2 said adaptor element having been adapted for the installation of locking provisions;

FIG. 10 is a superior view of the adaptor element of FIG. 2 showing the use of a security screw to operate locking provisions;

FIG. 11 is a superior view of the adaptor element of FIG. 2 showing the use of a key to operate locking provisions;

FIG. 12 is a vertical cross-sectional view through a medial plane of a first method of fixing the anchor element to a surface;

FIG. 13 is a fragmentary face view of a second method of fixing the anchor element to a surface;

FIG. 14 is a fragmentary face view of a third method of fixing the anchor element to a surface;

FIG. 15 is a fragmentary vertical cross-sectional view through a medial plane of the method of fixing of FIG. 14;

FIG. 16 is a side view of an alternative embodiment in which the adaptor element is pivotally supported to permit the angular displacement of the structural member.

### DETAILED DESCRIPTION OF ILLUSTRATIVE EMBODIMENTS

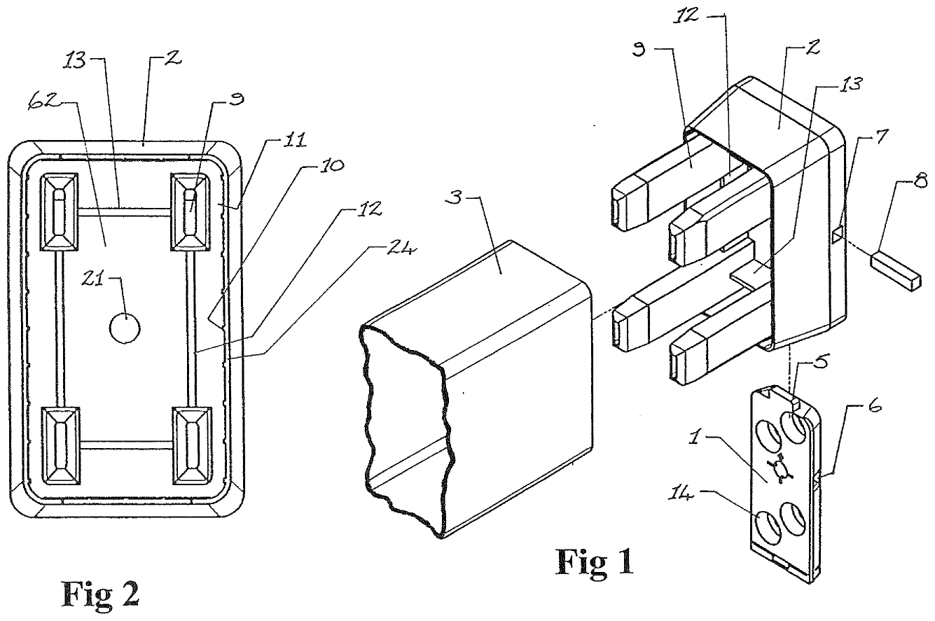

With reference to FIG. 1, a connection system adaptable to a variety of applications comprises an anchor element 1 able to be fixed to a primary structure or structural member in a variety of ways, an adaptor element 2 slidingly engaged with the parallel, angled side edges of said anchor element and lockable to said anchor element, and a secondary structural member 3 engaged with and secured to said adaptor element, said adaptor element being made in a range of forms to accommodate secondary structural members of a variety of transverse cross-sectional shapes. While it is common for primary structures and structural members to be of a vertical orientation and secondary structural members to be of a horizontal orientation, other orientations of both may be required, the present invention being adaptable to accommodate these.

Said anchor element takes the form of a rectangular block having a ratio of thickness to overall width falling in the range 1:7.5 to 1:15.

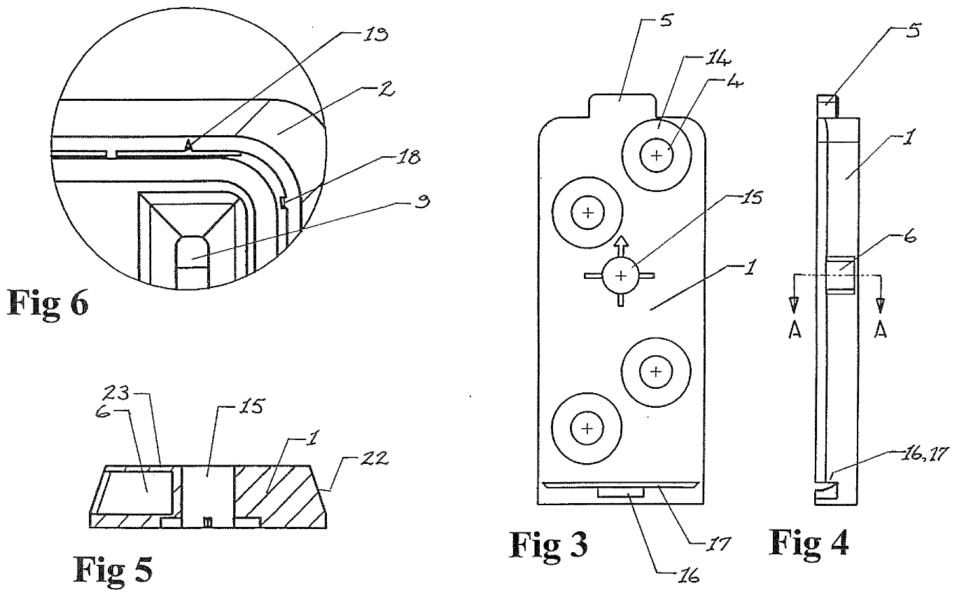

With additional reference to FIGS. 3 to 5, said anchor element has formed on its upper central edge a toe 5 which engages a complementary recess 20 in the upper edge of said adapter element (as depicted in FIG. 9), engagement of said toe with said recess acting as an indicator of the full seating of said adaptor element on said anchor element. A plurality of bores 4 pass through the thickness of said anchor element, two or more of said bores accommodating suitable fastenings employed to fix said anchor element to a surface. In the preferred embodiment, where said surfaces are of a polymer material or light-gauge metal alloy material, said fastenings take the form of self-drilling and self-tapping screws of the type commonly known as Tek Screws. Said bores are provided at their outer ends with suitable recesses 14 of a diameter and depth to fully accommodate the heads of said fastenings. Said anchor element is optionally provided with a generally centrally-located bore of suitable diameter passing through its thickness, the axis of said bore being collinear with the axis of a complementary bore 21 passing through body 62 of said adaptor element such that, when said adaptor element is fully seated on said anchor element, a single fastener passing through both said bores being optionally employed to lock said adaptor element to said anchor element. Said anchor element is optionally provided with an elongated recess 6 of square, rectangular or round cross-sectional shape located approximately medially in one side and extending inwardly (transversely) from one side for up to 50 per cent of the width of said anchor element, said recess coinciding with a complementary aperture 7 formed in the appropriate side of said adaptor element when said adaptor element is fully seated on said anchor element. A rod 8 of a suitable rigid material is inserted through said aperture and fully into said recess to lock said adaptor element to said anchor element, said rod being retained in place by frictional effects. Said anchor element having been fixed to a surface with its inner surface 23 abutting, said adaptor element is fixed to it by sliding down over said anchor element a longitudinally-arranged channel (depicted as 21 in FIG. 9) formed in the flat, inner surface of said adaptor element and having a width and depth complementary to those of said anchor element, said sliding engagement being continued until said toe is fully engaged with said complementary recess. Sides 22 of said anchor element are angled in the manner of the dovetail slideway of a machine tool, making said anchor element widest at its outer surface, the sides of said longitudinal channel being angled similarly, said angled surfaces acting to retain said adaptor element on said anchor element, the widths of said longitudinal channel and said anchor element being such as to just permit said sliding engagement.

Said adaptor element having been fixed to said anchor element, the end of a secondary structural member 3 is inserted into said adaptor element, the thickness of the walls of said secondary structural member being accommodated in peripheral zone 11 between the outer surfaces of outwardly-projecting, rigid fingers 9 positioned immediately adjacent and inwardly of the corners of the open end of said adaptor element and a plurality of narrow ribs 10 formed on the inner surface of skirt 24 formed around the periphery of said adaptor element, said ribs being arranged parallel to the longitudinal axis of said secondary structural member. Said fingers, located immediately inwards of the corners of the open end of said adapter element, act to guide said secondary structural member into said peripheral zone, elastically deflecting as required to accommodate the end thickness of said secondary structural member, said ribs acting to increase the frictional engagement of said secondary structural member with said adaptor element. Webs 12, 13 fixed to body 62 of said adapter element join said fingers and thereby provide bracing. Where more positive attachment of said secondary structural member to said adaptor element is required, said structural member is optionally bonded into place. Where a tensile force is to be applied to said structural member, suitable fastenings are employed to fix said structural member to said adaptor element.

With additional reference to FIG. 6, where said secondary structural member forms the top or bottom rail of a fence, gate or like structure it may be necessary to have another secondary structural member neatly abutting its upper or lower surface. As the adjacent said skirt of said adaptor element may prevent such abutment, provision is made to break out a panel from the appropriate lower or upper said skirt of said adaptor element, said panels being rendered readily removable by the provision of suitably located weakening grooves 19 formed in the inner surface of said skirt. Said panels are broken out simply by gripping them with a suitable implement and applying a modest force. Similarly, as the lower edge part of said anchor element may prevent such abutment, provision is made to break away said lower edge part, said lower edge part being rendered readily removable by the provision of a suitably located weakening groove 17 formed in the outer surface of said anchor element, a centrally-located recess 16 being provided for the insertion of a suitable implement to effect said breaking away.

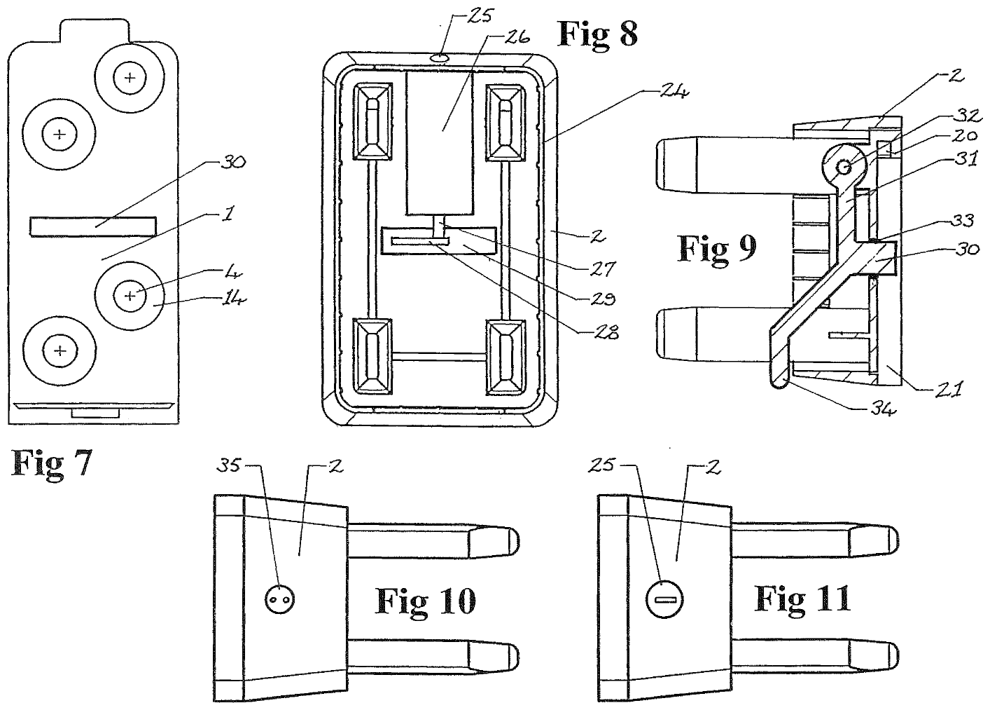

With reference to FIGS. 7, 8 and 11, in an alternative embodiment, said adaptor element is releasably locked to said anchor element by means of a key (not shown) inserted in a keyhole to operate a tumbler mechanism (not shown) accommodated within boss 26 formed on the interior of said adaptor element. Rotational displacement of said key and said tumbler mechanism in the correct sense causes rotation of shaft 27, thereby displacing tongue inwardly through aperture 29 provided in the inner wall of said adaptor element, allowing said tongue to engage complementary slot 30 provided in the outer surface of said anchor element. Location of said tongue in said slot of said anchor element and removal of said key acts to securely fix said adaptor element to said anchor element. If necessary, the end of said secondary structural member is cut away locally to accommodate said boss. With reference to FIG. 10, the lock mechanism described in relation to FIG. 8 is deleted and said shaft is simply turned by a tamper-proof screw of one of the types well known in the art. Such screw types include the Two Hole Screw (depicted as 35 in FIG. 10), 6-Lobe Star Drive Screw, Pin Hex Screw or Tri Slot Screw. The heads of said screws are recessed into said adaptor element to prevent their being gripped by pliers or similar tools, said adaptor element having been locked to said anchor element in the said way, can only be released using the appropriate tool. The locking in place of said adaptor element and, therefore, said secondary structural member is useful in situations where some secure form of temporary barrier or structure is required to be maintained for some time.

With reference to FIG. 9, in another alternative embodiment, said adaptor element is releasably locked to said anchor element by means of a plunger 30 passing through aperture 33 provided in the inner wall of said adaptor element to enter a complementary recess (not shown) formed in the outer surface of said anchor element. Said plunger is formed on arm 31 pivotally supported on pivot 32, spring means (not shown) being provided to urge said plunger into said recess. Said arm is extended to create concealed trigger 34 extending downwardly, access to said trigger being obtained through a suitable slot provided in the lower surface of said secondary structural member. The latching in place of said adaptor element and, therefore, said structural member is useful in situations where some form of barrier or structure is required to be temporarily maintained.

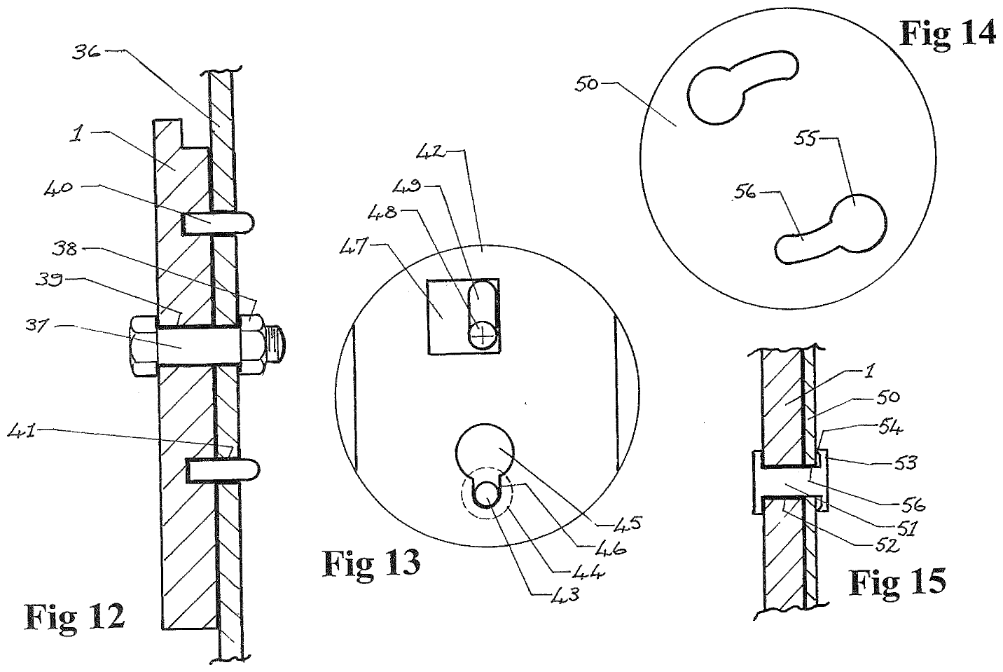

With reference to FIG. 12, in another alternative embodiment, anchor element 1 is fixed to metal plate surface 36 by means of a single bolt and nut 37, 38 passing through more or less centrally-located bore 39 in said anchor element. One or more short pins 40 protruding inwardly from said anchor element enter complementary bores in said metal plate and act to positionally locate said anchor element. Said embodiment provides ease of attachment and removal of said anchor element. Obviously, one or more single light fastenings passing through said anchor element and tapped into said metal plate may be used to stabilise the position of said anchor element in place of said pins, but with reduced ease of attachment and removal.

With reference to FIG. 13, in another alternative embodiment, anchor element 1 is fixed to surface 42 by means of two or more short pins 43 with enlarged heads (depicted in broken line as 44) passing through keyhole-type apertures in said surface. Said enlarged heads are passed through the larger openings 45 of said keyhole apertures, said anchor element then being linearly displaced to enter said pins into the narrow parts of said keyhole apertures, the lengths of said pins being such as to just provide a working clearance between said surface and the undersides of said enlarged heads. Accommodated within square or rectangular aperture 47 provided in said surface is blocking piece 49 rotationally supported from said anchor element on shaft 48, said shaft being rotatable in said anchor element using a simple tool. In the position of said anchor element in which said enlarged heads are presented to said larger openings, said blocking piece is positioned parallel to and adjacent the upper edge of said aperture. As said anchor element is displaced to enter said pins into said narrow parts of said keyhole apertures, said blocking piece is simultaneously displaced to a position in which it is parallel to and adjacent the lower edge of said aperture. Rotation of said shaft through 90 degrees in the appropriate sense then brings the free end of said blocking piece into contact with the upper edge of said aperture, thereby preventing displacement of said anchor element to release said headed pins. In the preferred embodiment, detents are provided to positively retain said blocking piece in its un-displaced and displaced positions. Said embodiment provides ease of attachment and removal of said anchor element. Obviously, one or more single light fastenings passing through said anchor element and tapped into said surface may be used to lock said anchor element in place on said surface, but with reduced ease of attachment and removal.

With reference to FIGS. 14 and 15, anchor element 1 is fixed to surface 50 by means of two or more two or more short pins 51 with enlarged heads 53 fixed in bores 52 in said anchor element engaging keyhole-type apertures in said surface. Said keyhole-type apertures comprise larger openings 55 extending from which are arcuate narrow parts 56. In fixing said anchor element to said surface, said enlarged heads are passed through said larger openings of said keyhole apertures, said anchor element then being rotationally displaced to enter said pins into the narrow parts of said keyhole apertures, the lengths of said pins being such as to just provide a working clearance between said surface and the undersides of said enlarged heads. In the preferred embodiment, the edges of said heads are turned down slightly to provide a frictional engagement with said surface. Rotation of said anchor element brings it into a position in which said adaptor element can be fixed to it, said adaptor element thus being positioned to receive said secondary structural member, engagement of said structural member with said adaptor element preventing rotation of said anchor element to release said pins from said keyhole-type apertures. Said embodiment provides ease of attachment and removal of said anchor element.

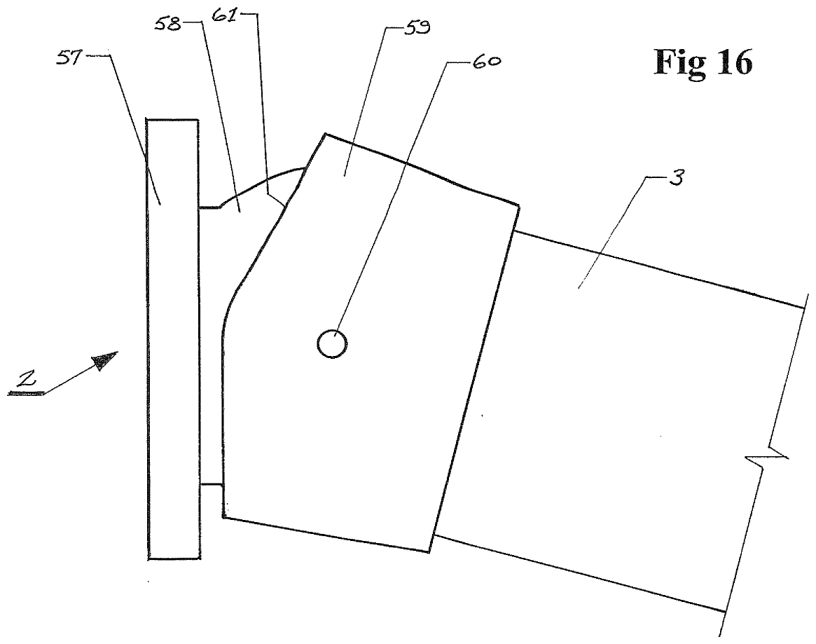

With reference to FIG. 16, an alternative embodiment, adaptor element 2 is fixed to said anchor element (not shown) in the manner described in relation to FIGS. 3 to 5, said channel with angled sides being formed in adaptor element base 57. Formed on said base are two outwardly-projecting, vertically-orientated, parallel supporting plates 58, adaptor collar 59 being pivotally supported on said supporting plates on pivot shaft 60. Secondary structural member 3 is inserted into said adaptor collar, said adaptor collar having the rigid fingers and plurality of narrow ribs formed on the inner surface of the skirt of said adaptor collar, said features being generally as described in relation to FIG. 2. In the preferred embodiment, said supporting plates are made part-circular and of a diameter and spacing such that they may be accommodated within said adaptor collar, said adaptor collar being enlarged as required to provide accommodation for said supporting plates. The angular freedom of movement of said adaptor collar is determined by the length and shaping of said supporting plates and the adaptation of said adaptor collar, such as the cutting away of inner edges 61.

In alternative embodiments (not shown), said adaptor element is made with a cavity shaped to receive secondary structural members of a variety of transverse cross-sectional shapes. Such cross-sectional shapes include, square, rectangular, round, oval, D-shaped, hexagonal, octagonal, ribbed, grooved or other specialised form.

The fact that mating components of the present invention are drawn to different scales is of no significance.

The present invention should be taken to include any feasible combination of features described herein.

Although the present disclosure has been described with reference to one or more examples, workers skilled in the art will recognize that changes may be made in form and detail without departing from the scope of the disclosure and/or the appended claims.

1. A connection system for joining members of a structure, said system comprising:
an anchor element fixable to a primary structure or structural member by a first fastener;
a locking element; and
an adapter element fixable to said anchor element, said adapter element being adapted to receive, support and be connected to an end of a secondary structural member, the system permitting an assembly created by the anchor element and the adapter element to be readily, partially or completely, dismantled; said adaptor element being slidingly engageable with complementary shapings of said anchor element and lockable in place on said anchor element by the locking element, said adapter element comprising a zone to receive an end of said secondary structural member and securable to said secondary structural member by frictional engagement, bonding or a second fastener.

2. The connection system of claim 1 wherein the connection system comprises said primary structure or structural member and is fixed and permanent, or removable.

3. The connection system of claim 1 in which said anchor element has formed on its upper central edge a toe which engages a complementary recess of said adaptor element, engagement of said toe with said recess acting to indicate that a full sliding engagement of said anchor element by said adaptor element has been achieved.

4. The connection system of claim 1 in which side surfaces of said anchor element are angled in the manner of a dovetail slideway of a machine tool, said anchor element being slidingly accommodated in a longitudinally-arranged channel formed in an inner surface of said adapter element, side surfaces of the adapter element are made with angling complementary to that of said anchor element, said angling of said surfaces acting to retain said adaptor element on said anchor element, relative widths of said longitudinally-arranged channel and said anchor element being such as to just permit said sliding engagement.

5. The connection system of claim 1 in which the zone of the adapter element comprises an opening shaped to receive any of a variety of transverse cross-sectional shapes of the end of the secondary structural member, including square, rectangular, round, oval, D-shaped, hexagonal, octagonal, ribbed, or grooved.

6. The connection system of claim 1 in which said anchor element takes a form of a rectangular block having a ratio of thickness to overall width falling in a range 1:7.5 to 1:15.

7. The connection system of claim 1 comprising a plurality of bores which pass through a thickness of said anchor element, two or more of said bores accommodating suitable fastenings employed to fix said anchor element to a said primary structure or structural member, said bores being provided at their outer ends with suitable recesses of a diameter and depth to fully accommodate heads of said fastenings.

8. The connection system of claim 1 in which said anchor element comprises a generally centrally-located bore of suitable diameter passing through a thickness of the anchor element, an axis of said bore being collinear with am axis of a complementary bore passing through said adaptor element when said adaptor element is fully seated on said anchor element, a single fastener passing through both said bores to lock said adaptor element to said anchor element.

9. The connection system of claim 1 in which said anchor element comprises an elongated recess of square, rectangular or round cross-sectional shape located approximately medially on one side and extending inwardly for up to 50 percent of a width of said anchor element, said recess coinciding with a complementary aperture formed in an appropriate side of said adaptor element when said adaptor element is fully seated on said anchor element,
the system further comprising a rod of a suitable rigid material which is insertable through said aperture and into said recess to lock said adaptor element to said anchor element, said rod being retainable in place in said elongated recess by frictional effects.

10. The connection system of claim 1 in which said adapter element comprises a peripheral zone to accommodate walls of said secondary structural member, the peripheral zone being formed between outer surfaces of outwardly-projecting, rigid fingers positioned immediately adjacent and inwardly of corners of an open end of said adaptor element and a plurality of narrow ribs formed on an inner surface of a peripheral skirt of said adaptor element, said ribs being arranged parallel to a longitudinal axis of said secondary structural member; said fingers being elastically deflectable to accommodate a wall thickness of said secondary structural member and acting to guide the end of said secondary structural member into said peripheral zone, said ribs acting to increase a frictional engagement of said secondary structural member with said adaptor element.

11. The connection system of claim 10, wherein the peripheral skirt comprises at least one break out panel, said at least one breakout panel being rendered readily removable by weakening grooves formed in an inner surface of said skirt, said at least one break out panel being breakable by gripping the panel with a suitable implement and applying a force.

12. The connection system of claim 11 in which the anchor element comprises a lower edge part and a weakening groove formed in an outer surface of the anchor element such that the lower edge part is readily removable, a centrally-located recess being provided for insertion of a suitable implement to effect a breaking away of the lower edge part.

13. The connection system of claim 1, wherein the adapter element comprises:
a keyhole,
a tumbler mechanism accommodated within a boss formed on an interior of said adaptor element,
a shaft and a tongue,
an aperture in an inner wall of said adaptor element, and
wherein the locking element comprises the keyhole, the tumbler mechanism and a key insertable into the keyhole to operate the tumbler mechanism; wherein rotational displacement of said key and said tumbler mechanism in a correct direction causes rotation of the shaft to inwardly displace the tongue through the aperture in the inner wall of said adaptor element, said tongue engaging a complementary slot provided in an outer surface of said anchor element; engagement of said tongue in said slot of said anchor element and removal of said key acting to securely fix said adaptor element to said anchor element.

14. The connection system of claim 1, wherein the adapter element comprises:
a keyhole,
a tumbler mechanism accommodated within a boss formed on an interior of said adaptor element,
a shaft and a tongue,
an aperture in an inner wall of said adaptor element, and
wherein said locking element comprises a tamper-proof screw, which turns said shaft, a head of said screw being recessed into said adaptor element to prevent the screw being gripped by pliers or similar tools;
once locked to said anchor element, said adaptor element can only be released using an appropriate tool.

15. The connection system of claim 1, wherein the adapter element comprises:
an aperture provided in an inner wall of said adaptor element;
a plunger passing through the aperture to enter a complementary recess formed in an outer surface of said anchor element, said plunger being formed on an arm pivotally supported on a pivot;
a spring positioned to urge said plunger into said recess;
said arm being extended to create a downwardly-extending trigger accessible through a suitable aperture provided in a lower surface of said secondary structural member, said trigger being displaced to withdraw said plunger, thereby releasing said adaptor element from said anchor element, and
wherein in which said locking element comprises the plunger which releasably locks said adaptor element to said anchor element.

16. The connection system of claim 1 in which said anchor element comprises:
a centrally located bore to receive a bolt securable with a nut; and
one or more short pins protruding inwardly from said anchor element and configured to enter complementary bores in a metal plate acting to positionally locate said anchor element.

17. The connection system of claim 1, which comprises two or more short pins with enlarged heads which are passable through keyhole-type apertures in a surface to fix said anchor element the surface, said anchor element then being linearly displaceable to enter said pins into narrow parts of said keyhole apertures, lengths of said pins being such as to just provide a working clearance between said surface and undersides of said enlarged heads; a shaft rotationally supported in said anchor element and supporting at its free end a blocking piece is rotatable using a simple tool to position said blocking piece within a square or rectangular aperture in said surface, thereby preventing displacement of said anchor element to release said headed pins; detents being provided to positively retain said blocking piece in un-displaced and displaced positions.

18. The connection system of claim 1, which comprises two or more short pins with enlarged heads fixed in bores in said anchor element to engage keyhole-type apertures in a surface to fix said anchor element to the surface, said keyhole-type apertures comprising larger openings extending from which are arcuately-arranged narrow parts; said anchor element being fixable to said surface by passing said enlarged heads through said larger openings of said keyhole apertures, said anchor element then being rotationally displaceable to enter said pins into the narrow parts of said keyhole apertures, lengths of said pins being such as to just provide a working clearance between said surface and undersides of said enlarged heads, edges of said heads being turned down slightly to provide a frictional engagement with said surface; wherein rotation of said anchor element to fully enter said pins into said narrow parts of said keyhole apertures brings the anchor element into a position such that, when said adaptor element is fixed to the anchor element, said adaptor element is positioned to receive the end of said secondary structural member, engagement of said secondary structural member with said adaptor element preventing rotation of said anchor element to release said pins from said keyhole-type apertures.

19. The connection system of claim 10 in which said adaptor element comprises first and second parts, the first part being fixable to said anchor element and a second part pivotally connected to said first part; a longitudinally-arranged channel of said first part being slidingly engageable with said anchor element; first and second outwardly-projecting, parallel, vertically-orientated supporting plates being formed on said first part; an adaptor collar being pivotally supported on said supporting plates on a pivot shaft passing through said plates; the end of said secondary structural member being insertable into said adaptor collar, said adaptor collar having said rigid fingers and said plurality of narrow ribs formed on the inner surface of said peripheral skirt; said supporting plates being part-circular and of a diameter and spacing such as to allow their accommodation within said adaptor collar; an angular freedom of movement of said adaptor collar and, therefore, of said secondary structural member being determined by a length and shaping of said supporting plates and an adaptation of said adaptor collar.

20. The connection system of claim 1 in which all elements of the connection system are made from polymer materials.
